(19) United States
(12) Patent Application Publication
(10) Pub. No.: US 2006/0108340 A1
(43) Pub. Date: May 25, 2006

(54) Apparatus for dynamic control of laser beam profile

(76) Inventor: Jan Lipson, Cupertino, CA (US)

Correspondence Address: IRELL & MANELLA LLP, 840 NEWPORT CENTER DRIVE, SUITE 400, NEWPORT BEACH, CA, 92660, US

(21) Appl. No.: 11/269,974

(22) Filed: Nov. 8, 2005

Related U.S. Application Data
(60) Provisional application No. 60/626,280, filed on Nov. 8, 2004.

(51) Int. Cl. B23K 26/067

(52) U.S. Cl. 219/121.76; 219/121.63; 219/121.64; 219/121.72

(57) ABSTRACT

A laser system that can be used to perform manufacturing process such as welding, cutting, drilling and marking a work piece. The laser system includes an array of laser diodes that each generate a laser beam. The laser beams may collectively create a beam that is directed onto the work piece. The system also includes a control circuit that can select and control the laser diodes to vary a characteristic(s) and/or profile of the beam. The control circuit may control the laser diodes so that an outer area of the beam has a higher intensity than an inner area of the beam.

### CROSS REFERENCE TO RELATED APPLICATIONS

This application claims priority to provisional Application No. 60/626,280, filed on Nov. 8, 2004.

### BACKGROUND OF THE INVENTION

1. Field of the Invention

The subject matter disclosed generally relates to the field of semiconductor lasers and a process of using an array of semiconductor lasers to perform work.

2. Background Information

Lasers are frequently used to perform work on different work pieces. For example, lasers are used to weld, cut, drill or mark a work piece such as a sheet of metal. The laser must be a high powered device such as a CO₂ or a YAG:Nd laser to perform such manufacturing process. Such high powered lasers typically generate a laser beam profile that has a uniform intensity profile across the diameter of the beam. A uniform intensity does not always provide the most desired result.

For example, referring to FIG. 1, a laser beam 2 may be directed onto a work piece 4 to weld the same. A laser beam with a uniform intensity distribution will create a thermal gradient across the weld. The center of the weld will be hotter than the outer weld areas. The higher temperatures in the center of the weld area create depression as shown in FIG. 1. The result is a less than robust weld.

Conventional laser systems used in manufacturing processes typically do not have the ability to vary the profile of the beam. Additionally, conventional high powered lasers are large in size and costs. It would be desirable to provide a relatively small, low cost, high powered laser system that can perform various manufacturing processes such as welding, cutting, drilling and marking.

### BRIEF SUMMARY OF THE INVENTION

A laser system that is used to perform work on a work piece. The laser system includes an array of laser diodes that each generate a laser beam. The system also includes a control circuit that can individually select and the laser diodes to create and define a beam that performs a selected process on the work piece.

### BRIEF DESCRIPTION OF THE DRAWINGS

FIGS. 1 is an illustration showing a laser weld of the prior art;

FIG. 2 is a schematic of a laser system;

FIG. 3A-C are illustrations showing an intensity profile of a beam during different times of a welding process;

FIG. 4 is a timing diagram showing pulse intensities of the beam during the welding process;

FIG. 5 is an illustration of a welded work piece;

FIG. 6 is an illustration of a work piece being welded;

FIG. 7 is an illustration of the work piece at a later time in the weld process;

FIG. 8 is an illustration showing two welded work pieces;

FIG. 9 is a graph showing power intensities versus time and work piece locations;

FIG. 10 is an illustration showing an embodiment of a laser diode array.

### DETAILED DESCRIPTION

Disclosed is a laser system that can be used to perform manufacturing process such as welding, cutting, drilling and marking a work piece. The laser system includes an array of laser diodes that each generate a laser beam. The laser beams may collectively create a beam that is directed onto the work piece. The system also includes a control circuit that can select and control the laser diodes to vary a characteristic(s) and/or profile of the beam. The control circuit may control the laser diodes so that an outer area of the beam has a higher intensity than an inner area of the beam.

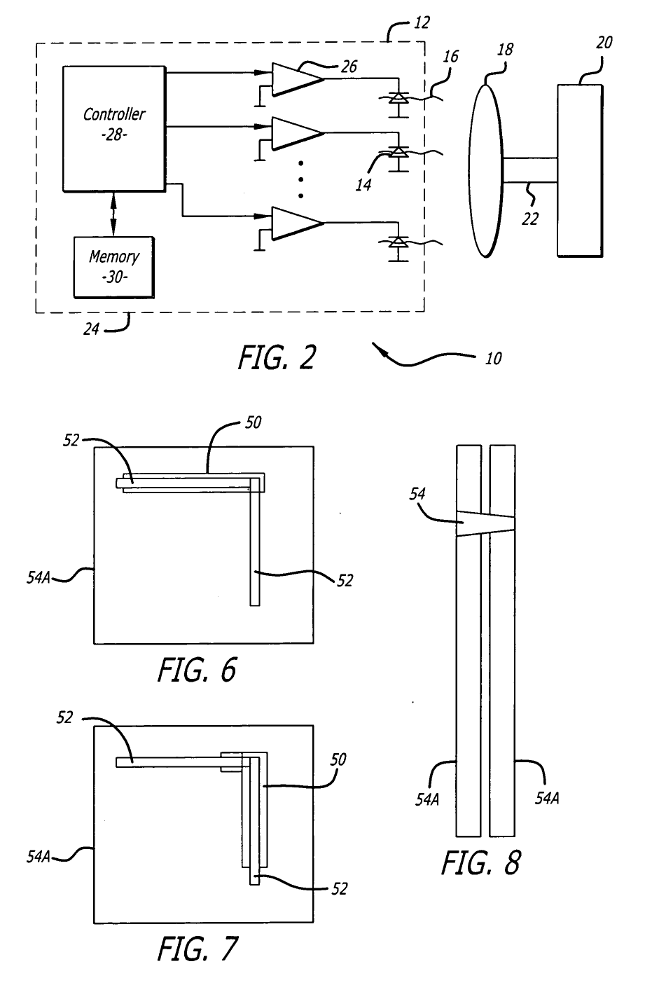

Referring to the drawings more particularly by reference numbers, FIG. 2 shows an embodiment of a laser system 10. The system 10 includes an array of laser diodes 12. The array 12 includes a plurality of individual laser diodes 14. Each laser diode 14 generates a laser beam 16. The beams 16 can be focused by a lens 18 onto a work piece 20. The lens 18 may contain a plurality of lenses and other optical components. The system may include a fiber optic cable (not shown) in lieu of or in addition to the lens 18 to direct the beams onto the work piece. The laser beams 16 may be focused and/or directed onto the work piece 20 collectively as a single beam 22.

The system 10 may include a control circuit 24 that selects and controls the operation of the laser diodes 14. The circuit 24 may include a plurality of driver circuits 26 that provide power to the laser diodes 14. The driver circuits 26 may be controlled by a controller 28. The controller 28 may be a microprocessor. The controller 28 may be connected to memory 30. The controller 28 may be operated in accordance with operations and data stored in memory. The operations and data may cause the laser diodes 14 to operate in various modes and/or routines. The modes and/or routines may include varying the timing of laser beam generation, and/or changing the profile and/or certain characteristics of the laser beams 16 and beam 22.

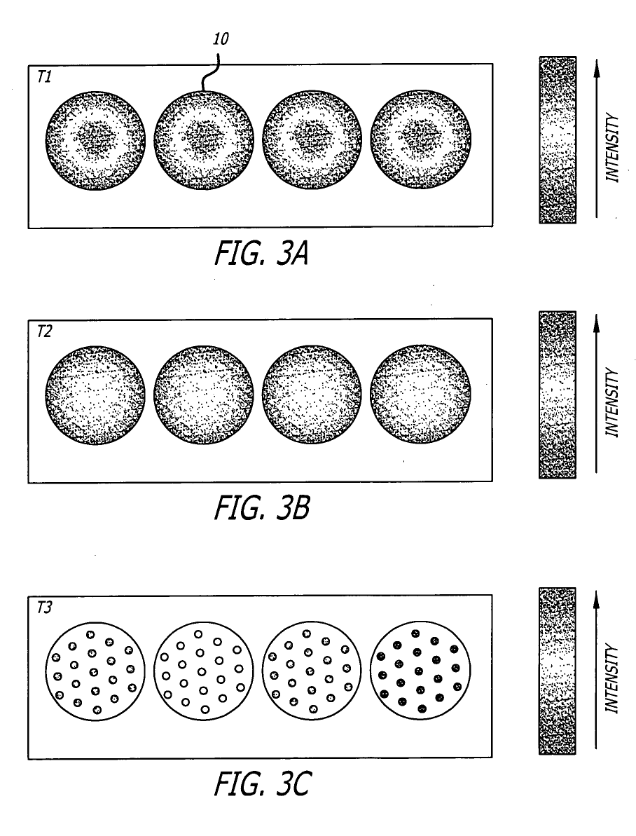

FIGS. 3A-C, 4 and 5, show a technique for varying the timing and intensity gradient of the beam 22 to weld two work pieces 40A and 40B. The controller 28 may initially cause the generation of a high intensity precursor pulse as shown in FIG. 4. The precursor pulse creates a “keyhole” in the work pieces 40A and 40B. The keyhole is a depression in the surface of the work piece that is partially filled with molten metal. The depression causes the beam to be reflected from its sidewalls to enhance the absorption of the beam. The increase in absorption improves the overall efficiency of energy transfer in the process.

At time T1 the controller 28 may select and control the laser diodes to create a non-uniform intensity gradient across the beam 22 as shown in FIG. 3A. For example, the controller 28 can control the driver circuits 26 so that laser diodes in an inner portion of the array generate laser beams with less intensity than laser beams generated in an outer area of the array. The result may be a more uniform temperature gradient across the weld area of the work piece.

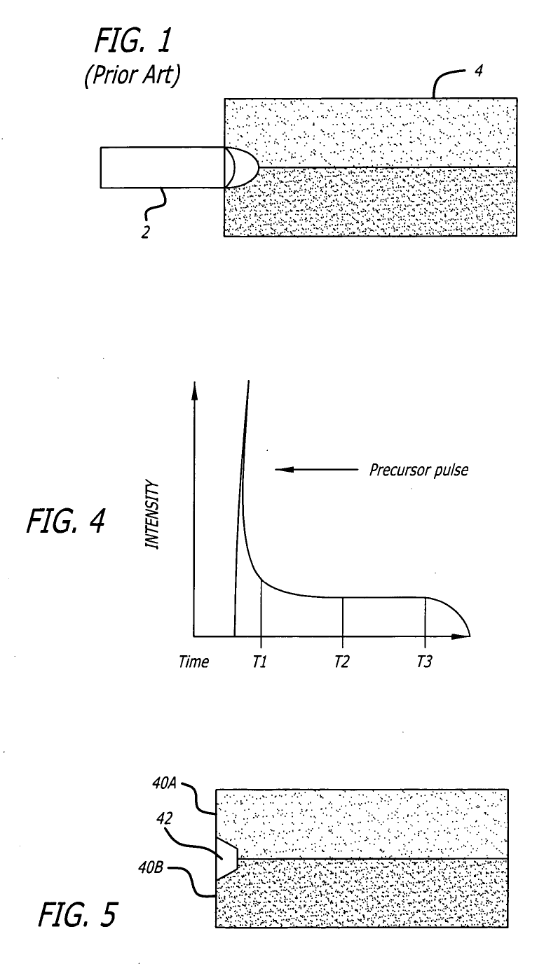

At time T2 the controller varies the output of the laser diodes to obtain a more uniform intensity gradient across the beam 22 as shown in FIG. 3B. At time T3 the controller 28 causes the generation of a beam with an essentially uniform intensity gradient as shown in FIG. 3C. As shown in FIG. 5 the result is a robust weld 42 (compare FIG. 5 to FIG. 1).

By way of example, to spot weld a work piece constructed of 304 stainless steel with a weld diameter of 0.4 mm, the total pulse energy delivered may be approximately 1 Joule. The total length of the welding pulse may be approximately 1 ms. The times T1, T2 and T3 may range between 0.01-0.2 ms, 0.2-0.8 ms, and 0.5-1.0 ms, respectively. The peak power of the precursor pulse may range between 2-10 kW.

FIGS. 6-8 show a welding process wherein the profile of the beam 50 is varied to match the weld pattern 52 on a work piece 54A welded to another work piece 54B. In this process there is relative movement between the beam and the work piece. This process is preferably performed with a two-dimensional array of laser diodes.

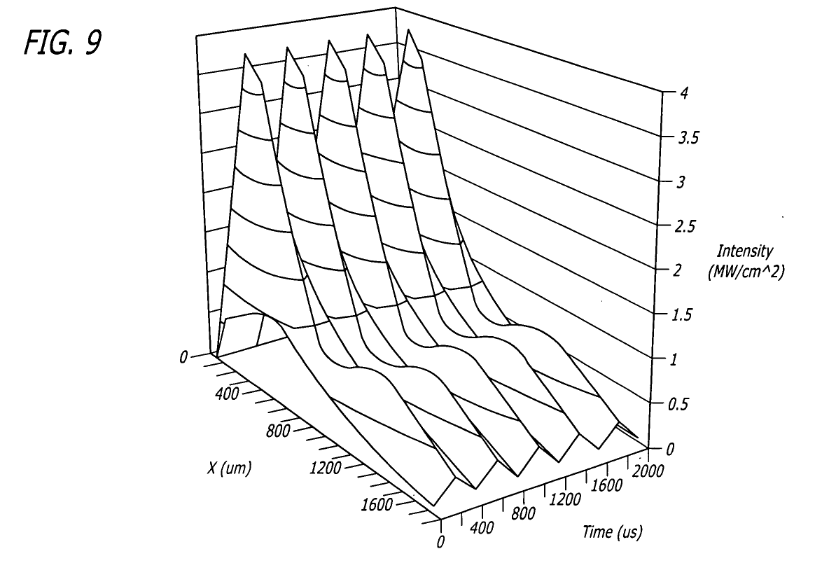

In general it is desirable to decrease the cooling rate of the work piece as it is being welded. Cracking is inversely proportional to the cooling rate. As show in FIG. 6 the beam 50 may have an elongated shape to extend the cooling period as the beam moves along the weld line 52. The controller may cause an initial precursor pulse to create a keyhole in the work piece. The beam intensity may be reduced as the work piece moves relative to the beam. An example of an intensity profile relative to time and work piece location is shown in FIG. 9.

Referring to FIG. 7, the weld pattern may have a bend. As the work piece moves relative to the beam 50 the controller 28 may select certain laser diodes from the two-dimensional array to create an L-shaped beam 50 that corresponds to the L-shape of the weld line 52. This creates an elongated beam that can reduce the cooling time of the weld along the entire weld line. FIG. 8 shows the resultant weld 54.

By way of example, the process may weld two galvanized steel sheets each having a thickness between 0.7-2.0 mm. The weld speed may be 1-4 meters per minute. The elongated beam may have a length of 3 mm and a width of 0.5 mm. At the initial work piece location (i.e. X=0) the intensity may range between 1-4 MW/cm². Pulses may be separated by 200-600 μs, with pulse widths between 50-200 μs. The average power density may be gradually reduced by a factor of 4. There may be negligible pulsing at X=800 μm and pulsing again at X=1600 μm. The power densities may range between 0.5-0.1 MW/cm².

The system 10 may be a station or part of a station that can perform different processes such as welding, cutting, drilling, marking etc. The controller 28 can control the laser diodes to obtain a beam for each type of process. Thus the system 10 may provide a single station that can weld, cut, drill, mark, etc., by creating different beam profiles. By way of example, the station may create a beam with a non-uniform profile for welding and a uniform profile for cutting. The station may include a screen with a keyboard (not shown) that allows an operator to select a process. The types of profiles can be stored in memory in a look-up table or other manner.

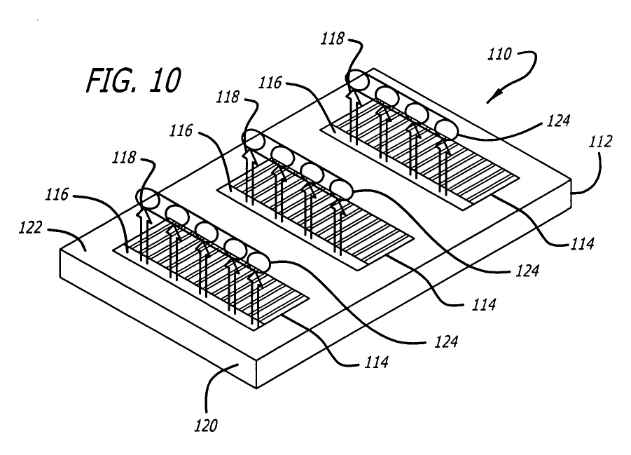

FIG. 10 discloses an embodiment of an array 112. The array may be fabricated as a semiconductive die 112 that contains a plurality of laser stripes 114 and one or more reflective elements 116. There is typically a reflective element 116 associated with a group of laser stripes 114. The laser strips 114 generate a plurality of laser beams 118 that travel toward an edge 120 of the die 112. The reflective element 116 reflects the laser beam 118 so that the beam 118 is emitted from a top surface 122 of the die 112. Each array 112 may include lenses 124 to focus the beams 118.

Although a vertical emitting laser diode array is shown and described, it is to be understood that the array can be constructed in variety of manners, including the assembly of horizontal emitting laser diodes or with an array of vertical cavity surface emitting lasers (VCSEL's).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A laser system used to perform work on a work piece, comprising:
an array of laser diodes, each said laser diode generates a laser beam; and,
a control circuit that can individually select and control said laser diodes to create and define a beam that performs a selected process on the work piece.

2. The system of claim 1, wherein said control circuit includes a plurality of driver circuits coupled to said laser diodes, and a controller coupled to said driver circuits.

3. The system of claim 1, wherein the process includes welding.

4. The system of claim 1, wherein said laser diodes are of a vertically emitting type.

5. The system of claim 1, wherein said laser diodes include at least one inner laser diode and at least one outer laser diode and said control circuit controls said laser diodes such that a laser beam generated by said inner laser diode has a lower intensity than a laser beam generated by said outer laser diode.

6. The system of claim 1, wherein said laser diodes collectively create a beam that has a length greater than a width.

7. The system of claim 1, wherein said control circuit controls said laser diodes to change a shape of said beam.

8. The system of claim 1, wherein said control circuit controls said laser diodes to vary an intensity gradient of said beam.

9. A laser system used to perform work on a work piece, comprising:
laser diode array means for generating a beam; and,
control circuit for controlling said laser diode control means to create and define a beam that performs a selected process on the work piece.

10. The system of claim 9, wherein said control circuit means includes a plurality of driver circuits coupled to said laser diode array means, and a controller coupled to said driver circuits.

11. The system of claim 9, wherein the process includes welding.

12. The system of claim 9, wherein said laser diode array means includes a plurality of laser diodes of a vertically emitting type.

13. The system of claim 9, wherein said laser diode array means includes a plurality of laser diodes that each generate a laser beam, said laser diode array means includes at least one inner laser diode and at least one outer laser diode and said control circuit means controls said laser diodes such that a laser beam generated by said inner laser diode has a lower intensity than a laser beam generated by said outer laser diode.

14. The system of claim 9, wherein said laser diode array means includes a plurality of laser diodes that each generate a laser beam, said laser diodes collectively create a beam that has a length greater than a width.

15. The system of claim 9, wherein said control circuit means controls said laser diodes to change a shape of said beam.

16. The system of claim 9, wherein said control circuit means controls said laser diodes to vary an intensity gradient of said beam.

17. A method for performing work on a work piece with an array of laser diodes, comprising:
selecting and controlling one or more laser diodes of a laser diode array to generate a plurality of laser beams that collectively create a beam; and,
directing the beam onto a work piece to perform the process.

18. The method of claim 17 further comprising varying a shape of the beam during the process.

19. The method of claim 17, wherein the laser diode array includes at least one inner laser diode and at least one outer laser diode and the laser beam generated by the inner laser diode has a lower intensity than a laser beam generated by the outer laser diode.

20. The method of claim 17, wherein the beam that has a length greater than a width.

21. The method of claim 17, further comprising changing a shape of the beam.

22. The method of claim 17, further comprising changing an intensity gradient of the beam.

23. The method of claim 17, wherein the beam welds the work piece.

24. The method of claim 17, wherein the beam cuts the work piece.

25. The method of claim 22, wherein the beam cuts the work piece.
